(19) United States
(12) Patent Application Publication
(10) Pub. No.: US 2002/0090323 A1
(43) Pub. Date: Jul. 11, 2002

(54) Gas scrubber with a device for preventing corrosion within a burning chamber

(75) Inventor: Dong-Soo Kim, Inchon (KR)

Correspondence Address: Kevin G. Rooney, Wood, Herron & Evans, L.L.P., 2700 Carew Tower, Cincinnati, OH, 45202, US

(73) Assignee: KOREA M.A.T. Co., Ltd.

(21) Appl. No.: 09/819,841

(22) Filed: Mar. 28, 2001

(30) Foreign Application Priority Data
Nov. 17, 2000 (KR) 2000-0068377

(51) Int. Cl. B01D 53/34; F01N 3/00; F28D 21/00

(52) U.S. Cl. 422/168; 422/173; 422/198

(57) ABSTRACT

A gas scrubber including a burning chamber to treat the gas with heat, a wetting chamber connected to the burning chamber which removes water soluble components contained in the gas flowing in from the burning chamber, and an outlet which exhausts the gas that has been treated. An insulation member is placed in a space between an outer wall and an inner wall of the burning chamber to prevent release of heat. A water supply pipe is placed between the inner wall and the insulation member. One end of the water supply pipe is an inlet in which water flows in and the other end is connected to the air supply pipe. Water that has turned into steam is led to the air supply pipe connected to the water supply pipe and released into the inside of the burning chamber along with air by the air supply pipe.

This application claims the priority of Korean Patent Application No. 2000-68377 filed Nov. 17, 2000, the disclosure of which is hereby fully incorporated by reference herein.

### TECHNICAL FIELD

This invention relates to a gas scrubber for treating gas generated during the manufacturing of a semiconductor device, more particularly a gas scrubber having a device for preventing corrosion of a compound metal which forms the inside of a burning chamber.

### BACKGROUND

Since a gas exhausted from the semiconductor manufacturing device contains a high degree of the toxic components, it must be purified before exhausted to the atmosphere. As illustrated in FIG. 1, a gas scrubber comprises an intake 1 where gas flows in to a gas scrubber, a burning chamber 3 to treat the gas with heat, a wetting chamber 5 which removes water soluble components contained in the gas flowing in from a burning chamber 3, and an outlet 2 which exhausts the gas that has been treated.

A conventional burning chamber, as shown in FIG. 2, is attached with an air supply pipe 11 and a housing formed with an outer wall 13a and inner wall 13b. An insulation member 15 is placed in a space between the outer wall 13a and the inner wall 13b. The gas induced into the burning chamber 3 contains elements such as F₂, NF₃, which corrode compound metals that form the inside of the burning chamber 3. The elements such as F₂, NF₃ contained in the gas corrode the compound metals of the burning chamber 3 while the gas is being treated in the burning chamber 3 and, as a result, the lifespan of the gas scrubber is shortened.

### SUMMARY

According, it is an object of the present invention to resolve the foregoing problems of the conventional gas scrubber by providing a gas scrubber comprising a burning chamber to treat the gas with heat, a wetting chamber connected to the burning chamber which removes water soluble components contained in the gas flowing in from a burning chamber, and an outlet which exhausts the gas that has been treated. An insulation member is placed in a space between an outer wall and an inner wall of the burning chamber to prevent release of heat. A water supply pipe is placed between the inner wall and the insulation member and one end of the water supply pipe is an inlet in which water flows in and the other end is connected to the air supply pipe. Water that becomes steam is led to the air supply pipe connected to the water supply pipe and released into the inside of the burning chamber along with air by the air supply pipe.

### BRIEF DESCRIPTION OF THE DRAWINGS

FIG. 1 is a partial sectional view of a conventional gas scrubber.

FIG. 2 is a partial sectional view of the conventional burning chamber of the gas scrubber of FIG. 1.

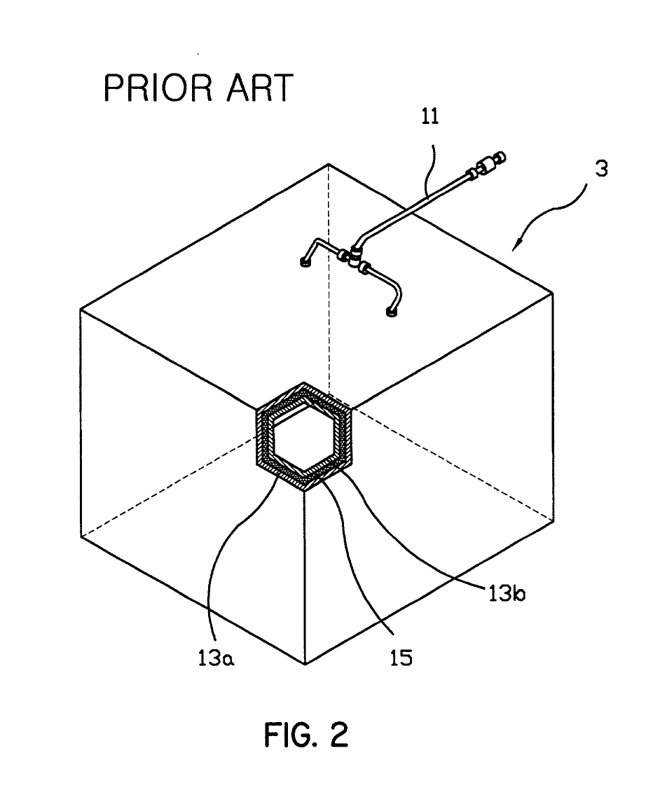

FIG. 3 is a partial sectional view of a burning chamber in accordance with the present invention which prevents a corrosion of a compound metal which forms the inside of a burning chamber.

DESCRIPTION OF THE PREFERRED EMBODIMENT

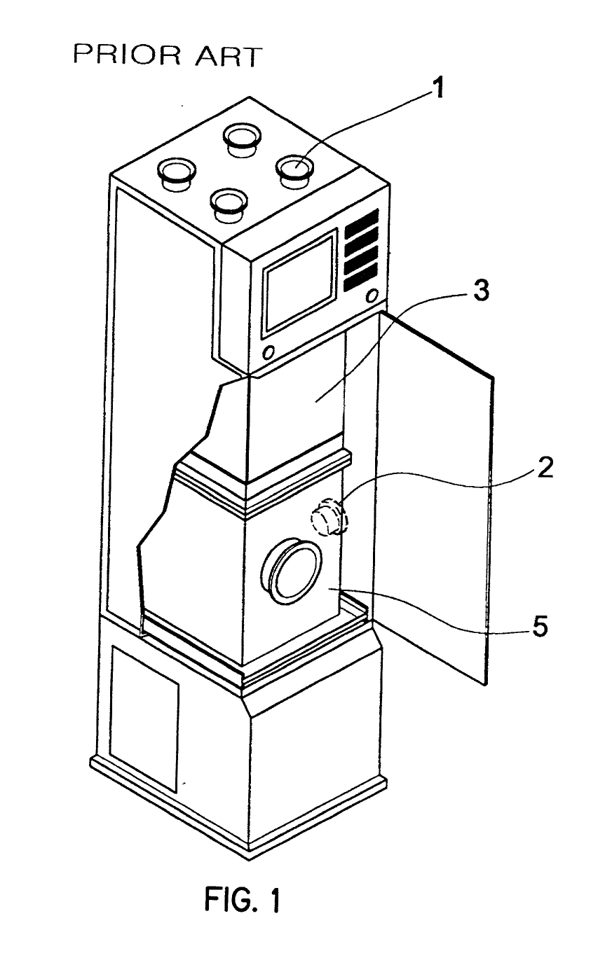

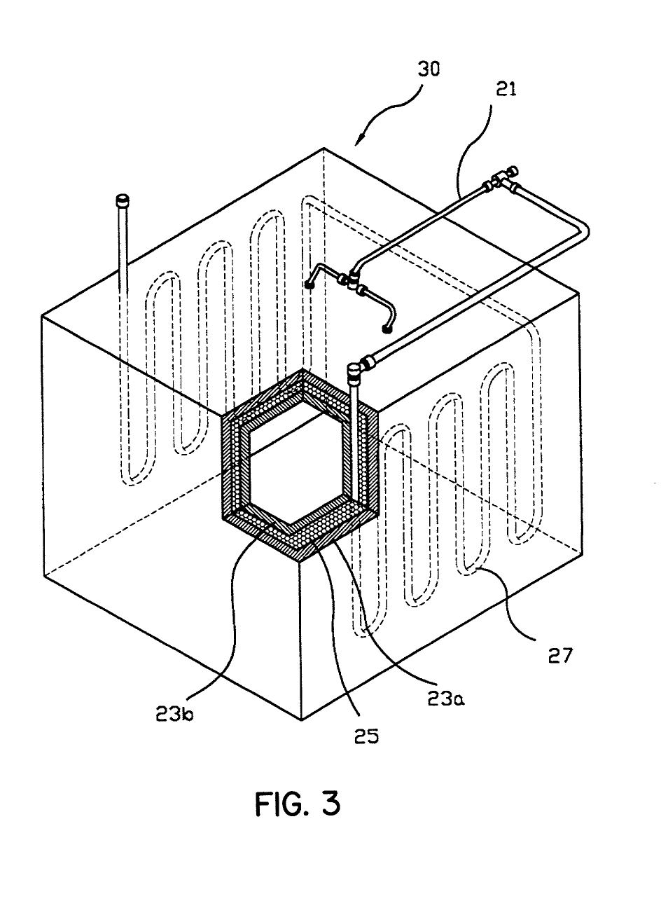

Referring to FIGS. 1 and 3, a gas scrubber in accordance with the invention comprises an intake 1 where gas flows into a gas scrubber, and a burning chamber 30 to treat the gas with heat. A wetting chamber 5 removes water soluble components contained in the gas flowing in from a burning chamber 30. An outlet 2 exhausts the gas that has been treated. The burning chamber 30, as shown in FIG. 3, in accordance with the present invention is attached with an air supply pipe 21 and a housing formed with an outer wall 23a and inner wall 23b. An insulation member 25 is placed in a space between the outer wall 23a and the inner wall 23b to prevent release of heat. A water supply pipe 27 is placed in between the inner wall 23b and the insulation member 25 throughout the housing of the burning chamber 30. One end of the water supply pipe 27 is an inlet in which water flows in and the other end is connected to the air supply pipe 21.

When water is supplied to the water supply pipe 27 placed in the inside of the housing, water is heated by the heat generate from the burning chamber 3 and becomes steam while flowing through the water supply pipe 27. Thereafter, water that has turned into steam is led to the air supply pipe 21 connected to the water supply pipe 27 and released into the inside of the burning chamber along with air by the air supply pipe 21. When mixed with F₂ and NF₃, the steam creates chemical reactions which convert F₂ and NF₃ into HF, HOF, HNO₂ and FNO₂.

The followings are the chemical reactions that take place within the burning chamber when steam is supplied

| | | |
|---|---|---|
| 2F₂ + 2H₂O | −> | 4HF + O₂ |
| NF₃ + H₂O | −> | 2HF + NOF |
| 2NF₃ + 3H₂O | −> | 3HF + 3HOF + N₂ |
| NF₃ + 2H₂O | −> | 3HF + HNO₂ |
| NF₃ + 2H₂O | −> | 2HF + FNO₂ + H₂ |

HF, HOF, HNO₂ and FNO₂ created as a result of the chemical reactions between F₂ and NF₃ and the steam have much lower corrosiveness when compared with F₂ and NF₃, thus the durability of the system is enhanced. Moreover, HF, HOF, HNO₂ and FNO₂ have a higher water solubility, therefore, the gas is more effectively treated in the wetting chamber, and the overall gas treating efficiency of the gas scrubber equipped with the present invention is improved.

The gas scrubber in accordance with the present invention as illustrated in the foregoing description utilizes the steam which reacts with F₂ and NF₃, and converts F₂ and NF₃ into HF, HOF, HNO₂ and FNO₂ thus the durability of the system is enhanced.

Although the invention has been shown and described with respect to detailed embodiments thereof, it should be understood by those skilled in the art that various changes and omissions in form and detail may be made therein without departing from the spirit and the scope of the invention.

What is claimed is:

1. A gas scrubber comprising:
a burning chamber to treat the gas with heat,
a wetting chamber connected to the burning chamber which removes water soluble components contained in the gas in from the burning chamber,
an outlet which exhausts the gas that has been treated,
an insulation member placed in a space between an outer wall and an inner wall of said burning chamber to prevent release of heat,
a water supply pipe placed between the inner wall and the insulation member, one end of the water supply pipe being an inlet in which water flows in and the other end connected to the air supply pipe,
wherein water in said water supply pipe turns into steam and is led to the air supply pipe connected to the water supply pipe and released into the inside of the burning chamber along with air by the air supply pipe.
